(19) United States
(12) Patent Application Publication
(10) Pub. No.: US 2026/0111580 A1
(43) Pub. Date: Apr. 23, 2026

(54) Method and System for Role-Based Access Control, Conditional Release, and Decryption of Encrypted Digital Data Vaults

(71) Applicant: Rodney Edward Ast, White Rock (CA)

(72) Inventor: Rodney Edward Ast, White Rock (CA)

(21) Appl. No.: 19/198,071

(22) Filed: May 4, 2025

Related U.S. Application Data
(63) Continuation-in-part of application No. 18/920,860, filed on Oct. 19, 2024.

(51) Int. Cl. G06F 21/62; G06F 21/60

(52) U.S. Cl. CPC G06F 21/6209; G06F 21/602; G06F 2221/2141

(57) ABSTRACT

A computer-implemented system and method are disclosed for secure encryption, decentralized storage, and conditional decryption of digital data using a role-based access control (RBAC) framework. A data owner registers trustees and assigns roles including validation, key holder, and file holder, each governed by RBAC policies. Encrypted data is encapsulated within an encrypted data vault (EDV), which includes trigger conditions, trustee instructions, and configurable parameters for key release delay and scheduled release with an optional safety-net period.

The EDV is processed in a secure enclave, where decryption keys are generated, wrapped with post-quantum cryptography, and distributed through a key management system. The encrypted data is stored decentrally. Access to the EDV is enabled only upon collaborative validation of trigger events by trustees, satisfaction of RBAC policies, and time-based conditions. After decryption, the EDV automatically resets, requiring renewed validation for future access.

### CROSS REFERENCE TO RELATED APPLICATION

This application is a Continuation-in-Part (CIP) of U.S. patent application Ser. No. 18/920,860, filed on Oct. 19, 2024, which is hereby incorporated by reference for all purposes as if fully set forth herein.

### FIELD OF THE INVENTION

The present invention relates to the fields of cryptography, secure data sharing, and digital storage. In particular, it concerns systems and methods for role-based access control (RBAC) of encrypted digital data vaults, supporting conditional and policy-driven access, decentralized storage, and secure trustee management.

### BACKGROUND OF THE INVENTION

In today's digital age, many individuals and organizations store sensitive data electronically, often encrypted to protect it from unauthorized access. However, a significant challenge arises when a data owner wishes to share this data with designated trustees for future use, without immediate access, and based on certain trigger events or conditions such as the owner's death, incapacitation, or other conditions.

Existing systems typically either provide immediate access to trustees upon sharing or rely on manual processes for event or condition verification, which can introduce vulnerabilities or inefficiencies. Furthermore, traditional methods often lack decentralized storage mechanisms, making the system prone to single points of failure.

The need exists for a secure, future-proof method that allows digital data owners to conditionally release encrypted data only upon the occurrence of predefined events or conditions. The present invention addresses these needs by enabling encrypted data to be stored and shared securely, with decryption triggered by predefined events or conditions.

The above information disclosed in this background section is only for enhancement of understanding of the background of the inventive concept, and, therefore, it may contain information that does not form the prior art that is already known to a person of ordinary skill in the art.

### SUMMARY OF THE INVENTION

The present invention provides a method and system for the controlled release of decryption keys, decryption, and distribution of encrypted digital data vaults, triggered by predefined conditions set by the data owner. The system is facilitated by a third-party server that manages secure registration of the data owner and trustees, assignment of trustee roles, encryption and decentralized storage of data, and validation of RBAC policies including collaborative trustee validation of trigger events or conditions prior to decryption. The invention is encryption-algorithm agnostic and post-quantum ready, supporting flexible, policy-driven access to sensitive data.

Key features of the invention are:

a. Secure Registration and Role Assignment:

Secure registration of data owners and trustees on a third-party server, with flexible assignment of trustee roles including storage, validation, and decryption, governed by role-based access control (RBAC) policies. Trustees may be designated at vault creation, regardless of registration status, with operational status contingent on completion of registration.

b. Decentralized Storage:

Encrypted data is stored in a decentralized manner across multiple storage nodes or trustee devices, reducing the risk of compromise from a single point of failure and enhancing data resilience.

c. Collaborative Validation of Access Conditions:

Access to encrypted data is enabled only upon satisfaction of RBAC policies, which may require collaborative validation by trustees of predefined conditions, such as event occurrences, or other owner-specified criteria. No single trustee can access the data without fulfillment of the defined collaborative policy.

d. Time Delay Before Decryption Key Release (Optional):

The data owner may configure an optional time delay between satisfaction of RBAC policies including collaborative validation of events or conditions and decryption key release to key trustees, creating a vault owner isolation period. During this period, the owner can review or intervene before keys are released to trustees, providing an added layer of security and control. If no action is taken, the key is automatically released after the delay.

e. Vault Recovery and Auto-Key Release (Optional):

An optional secondary encrypted data vault (EDV) opening mechanism enables scheduled, datetime-based decryption key release with a configurable safety-net delay for owner intervention. The scheduled release mechanism must be elected and configured by the data owner at the time of EDV creation, and the scheduled datetime can only be set forward (i.e., to a future date/time, like a deadman switch). If a safety-net period is configured, it must also be set at the time of EDV creation and is immutable thereafter. If the owner does not intervene during the safety-net period, the decryption key is automatically released to key trustees.

f. Automatic Vault Lock Reset After Decryption and File Save:

Upon successful decryption and saving of the vault file by the owner or a key trustee, the vault automatically resets to a locked state, preventing further decryption key release. If more than one key trustee is designated, a predefined countdown timer is initiated after the first key trustee's decryption and file save, allowing additional key trustees to decrypt and save the file within the allotted time. After the timer expires, the vault automatically resets to a locked state. This mechanism ensures that subsequent access requires a new round of RBAC collaborative policy validations.

g. Encryption-agnostic and Post-quantum Ready Security:

The system is encryption-algorithm agnostic and post-quantum ready, utilizing industry-standard end-to-end hybrid encryption, secure enclave environments (hardware-based or cloud-based) for sensitive data processing, and mechanisms such as attempt attestation wrappers and post-quantum key wrapping for enhanced brute-force resistance.

h. Audit Trails and Notifications:

Support for industry-standard audit trails, immutable time clock synchronization, and automated notifications to all users associated with a vault-including owners, trustees, and any additional roles designated by the data owner-ensuring that all relevant parties are kept informed of vault status, key events, and operational changes. This comprehensive notification framework further enhances transparency, collaborative awareness, and operational security.

### DETAILED DESCRIPTION OF THE INVENTION

In the following description, for the purposes of explanation, numerous specific details are set forth to provide a thorough understanding of various exemplary embodiments. It is apparent, however, that various exemplary embodiments may be practiced without these specific details or with one or more equivalent arrangements.

The terminology used herein is for the purpose of describing embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

The present invention provides a computer-implemented method for the controlled release of decryption keys, decryption, and distribution of encrypted digital data vaults, governed by flexible, role-based access control (RBAC) policies and triggered by predefined conditions or events (trigger events) set by the data owner. The system is facilitated by a third-party server that manages secure registration of the data owner and trustees, assignment of trustee roles, encryption and decentralized storage of data, and validation of RBAC policies—including collaborative trustee validation of trigger events prior to decryption. The invention is encryption-algorithm agnostic and post-quantum ready, utilizing industry-standard end-to-end hybrid encryption and secure, isolated enclave environments for all sensitive data processing operations. A key feature is that no single trustee can access the data without fulfillment of the collaborative RBAC policy, ensuring secure, conditional, and policy-driven access to sensitive digital information.

Registration and Assignment of Roles: The first step of the method involves secure registration of the data owner on a third-party server. The data owner uploads the digital data to be protected and selects trusted contacts (digital data trustees) to be associated with the vault. Trustees may be designated at the time of vault creation, regardless of whether they have completed user registration; the encrypted data vault remains inoperable until all designated trustees have completed registration.

Each trustee is assigned one or more predefined roles, which govern their access rights and responsibilities under the system's role-based access control (RBAC) policies. The primary roles include, but are not limited to:

Trust Circle (Validation Trustee): Responsible for initiating the vault opening process by submitting an independent request to open the vault after validating the occurrence of a predefined trigger event or condition. Collaborative validation by all or a policy-defined subset of trust circle trustees is required for vault unlocking.

File Holders (Storage Trustee): Trustees who receive and store encrypted copies of the digital data set. Distribution of the encrypted data is decentralized, with each file holder trustee receiving a full encrypted copy to enhance data resilience and reduce single points of failure.

Key Holders (Decryption Trustee): Trustees who are authorized to receive the decryption key after the vault has been unlocked in accordance with the RBAC policy. Key holders may decrypt the digital data set once all required validations and any optional time delays or owner safety-net periods have elapsed.

Additional roles or combinations of roles may be assigned as required by the data owner or system policy, supporting flexible and granular control over access, storage, validation, and decryption operations. This role assignment structure enables secure, policy-driven collaboration among trustees and supports a wide range of conditional access scenarios.

Encryption and Decentralized Storage: the present invention is encryption-algorithm agnostic and post-quantum ready, supporting the use of any current or future cryptographic standards without requiring fundamental redesign. In preferred embodiments, digital data uploaded by the data owner is encrypted using industry-standard, end-to-end hybrid encryption, processed within a secure, isolated enclave environment. This architecture ensures that all sensitive cryptographic operations, including encryption, key generation, and key wrapping, are performed in a manner that prevents the platform operator or any unauthorized party from accessing plaintext data or decryption keys at any stage. The system accommodates both client-originated encryption and server-side encryption workflows, with all persistent encryption key management performed exclusively within secure, isolated enclave environment (which may be hardware-based, cloud-based, or virtualized) and external key management systems. Users and trustees are never required to manage or retain encryption keys, ensuring a zero-knowledge security posture for all parties except those authorized by RBAC policy.

The invention does not depend on any specific client-side or server-side encryption methodology; rather, it accommodates a range of cryptographic workflows, including but not limited to client-originated encryption, enclave-based decryption and re-encryption, and key management via external key management systems and is not limited to any particular encryption, decryption, or key management approach. All encryption keys are generated and managed in secure, isolated environments, with decryption keys wrapped using post-quantum cryptography and stored exclusively in external key management systems. Temporary data and keys processed within the enclave are securely deleted upon completion in accordance with industry best practices.

The encrypted data set is further protected by an attempt attestation wrapper to resist brute-force decryption attempts and is distributed in full to designated file holder trustees and/or the data owner for decentralized storage. Metadata required for access management, including trustee roles and RBAC policies, is maintained separately from the encrypted data and keys.

The core of the invention is the application of flexible, policy-driven role-based access control (RBAC) to govern conditional release and decryption of the encrypted data vault, triggered by predefined events or conditions set by the data owner. The encryption and key management architecture is designed to be modular and adaptable, ensuring long-term security, operational flexibility, and compliance with evolving cryptographic standards, while supporting the system's primary innovations in conditional access control and decentralized storage.

Defining Predefined Trigger Events: The data owner specifies one or more predefined conditions that will initiate the decryption process for the encrypted data vault. These conditions may include, but are not limited to:
a. the death or incapacitation of the owner;
b. accidents, emergencies, or disasters;
c. a specific future date or milestone;
d. any other owner-defined event, circumstance, or policy-driven condition.

If the data owner elects to use a scheduled (datetime-based) release (vault recovery/auto key release) with a safety-net period for owner intervention, the scheduled release mechanism must be elected and configured at the time of EDV creation, the scheduled datetime can only be set forward (i.e., to a future date/time), and the safety-net period must be set at the time of EDV creation and is immutable thereafter.

The third-party server records each predefined trigger condition specified by the data owner, together with any associated instructions and the roles of trustees involved in the conditional access workflow. This flexible framework allows the data owner to tailor access policies to a wide range of personal, business, or regulatory scenarios, supporting event-driven and other RBAC-governed criteria for controlled data access.

Collaborative Validation of Trigger Event: Upon the occurrence of a predefined trigger event or condition, each trust circle trustee independently logs in to the third-party server and submits a request to open the encrypted data vault, providing confirmation of the event or condition. The system requires collaborative validation in accordance with an RBAC policy defined by the data owner, which may require unanimous, majority, or other threshold agreement among trust circle trustees before the vault can be unlocked and the decryption process initiated. If the required level of trustee validation is not achieved, the vault remains locked and inaccessible. This collaborative validation mechanism ensures that no single trustee can unilaterally authorize access, providing a robust layer of security and trust for conditional data release.

Decryption Key Release and Optional Time Delay: Once the required collaborative validation (such as unanimous agreement of all trust circle trustees) has been achieved, the decryption key is prepared for release to the designated key trustees. If the data owner has enabled the optional time delay feature, the release of the decryption key is postponed for a predefined period specified by the data owner. During this delay, the data owner may review the vault contents or intervene before the key holders gain access, providing an additional layer of control and security. If no action is taken by the data owner during the time delay, the system automatically releases the decryption key to the key holders at the end of the time delay period.

If the data owner configures a scheduled (datetime-based) vault recovery/auto key release, the scheduled release must be set forward (to a future date/time) at the time of EDV creation, and any safety-net period for owner intervention must be set at the time of EDV creation and is immutable thereafter.

Data Owner Decryption and Automatic Vault Lock Reset: If, during the time delay, the data owner decrypts and saves the vault file, the vault automatically resets to a locked state, preventing further decryption key release until a new round of collaborative validation is satisfied. This auto-lock mechanism ensures that each access event is securely controlled and requires renewed authorization.

Key Trustee Decryption and Automatic Vault Lock Reset: If, after release of the decryption key, a key trustee decrypts and saves the vault file, the vault automatically resets to a locked state, preventing further decryption key release until a new round of collaborative validation is satisfied. If more than one key trustee is designated, a predefined countdown timer may be initiated after the first key trustee's decryption and save, allowing additional key trustees to decrypt and save the file within the allotted time, after which the vault is automatically relocked. This auto-lock mechanism ensures that each trustee access event is securely controlled and requires renewed authorization, maintaining the security and integrity of the vault.

An embodiment of the invention discloses a method that comprises the steps of:
a. registering the data owner on a third-party server;
b. registering data trustees selected by the data owner;
c. assigning predefined roles to trustees, including but not limited to validation, storage, or decryption roles;
d. uploading client-side encrypted data from the data owner to the third-party server (with client-side encryption used solely for secure transit and not requiring user key management) and simultaneously saving and storing all associated metadata (including vault name, universally unique identifier (UUID), trigger definitions, trustee roles, RBAC policies, and access parameters) on the third-party server for access management and workflow orchestration;
e. decrypting the uploaded client-side encrypted data within a secure, isolated enclave environment;
f. re-encrypting the data set within the enclave using industry-standard, algorithm-agnostic encryption (SSE);
g. applying a vault attempt attestation wrapper to the encrypted data set within the enclave;
h. distributing the encrypted data set to file holder trustees and the data owner for decentralized storage;
i. routing and storing encrypted data set meta data to the platform server for access management and workflow orchestration, linking it to the owner-provided metadata;
j. generating a decryption key within the enclave and wrapping it using post-quantum ready methods;
k. storing the wrapped decryption key in an external key management system;
l. deleting temporary copies of the data from the enclave and server;
m. receiving independent open vault requests from validation trustees upon occurrence of a trigger condition;
n. performing collaborative validation in accordance with the RBAC policy;
o. if enabled, initiating an optional time delay before releasing the decryption key;
p. if configured by the data owner at the time of EDV creation, initiating a vault recovery or auto-key release mechanism as an alternative path for decryption key release, wherein the scheduled datetime can only be set forward (to a future date/time), and any safety-net period, if elected, must be set at the time of EDV creation and is immutable thereafter;
q. releasing the decryption key to key trustees after RBAC policy, time delay, or vault recovery mechanism are satisfied;
r. allowing key trustees to decrypt the encrypted data set;
s. automatically resetting the vault to a locked state after decryption and save by the data owner or any key trustee.

The encrypted digital data set is stored in a decentralized manner by distributing copies to trustees and to the data owner. The digital data is temporarily stored on the third-party server solely for encryption, decryption, and distribution purposes.

The invention discloses secure registration of the data owner and trusted contacts (digital data trustees) on a third-party server. The data owner registers an account, resulting in the creation of a unique user account on the third-party server. Trustees selected by the data owner are also registered (or may be assigned roles prior to completing registration) and are assigned predefined roles, including validation (trust circle), storage (file holder), and decryption (key holder), to manage collaborative event validation, storage, and decryption of the encrypted data.

The registration of the data trustees comprises adding the trustees as contacts in an address book. The selected trustees are sent email invitations prompting them to register themselves. The trustees then complete their registration, and their accounts are created on the third-party server. The presence and activation of the owner's address book on the third-party server reflects the successful registration of each trustee. If any selected trustee remains unregistered, the vault is flagged as inoperable until all trustees complete their registration, at which point the vault becomes fully operational.

The predefined roles may comprise trust circle role, file holder role, and key holder role. There may be more types and categories of the roles. Each role is assigned to a different group of the trustees. Each group of the trustees may comprise one or more trustees and each trustee may be assigned a single role or multiple roles. The system supports assignment of additional or custom roles as required by the data owner or organizational policy, enabling flexible RBAC configurations.

The first group of trustees, assigned with the role of trust circle, is responsible for submitting independent requests to open the vault after validating that the trigger event has occurred. Collaborative validation is performed in accordance with the RBAC policy defined by the data owner, such that the vault is opened only when the required level of trustee validation (e.g. unanimous, majority, or other threshold) is achieved.

The second group of trustees, assigned with the role of file holders, receives the encrypted digital data set delivered to them by the third-party server at the time of encrypted data vault creation for decentralized storage. The encrypted data set may be distributed to file holders and the data owner using secure delivery methods, such as email or secure download link, as appropriate.

The third group of trustees, assigned with the role of key holders, receives the decryption key released after the vault has been opened through collaborative validation by the trust circle trustees in accordance with the RBAC policy defined by the data owner, after any optional time delay set by the data owner, or via an auto key release mechanism if configured and uses the decryption key to decrypt the digital data set.

The encrypted data vault is created by the data owner on the third-party server and comprises a definition of the trigger event or condition under which the vault is to be opened by the trustees, as well as instructions specified by the data owner to be followed by the trustees if the trigger or condition occurs. The system supports creation of the vault even if some trustees have not yet completed registration, in which case the vault is flagged as inoperable until all designated trustees are registered. The trigger for vault opening may be an event, a condition, or any policy-driven rule defined by the data owner.

The encrypted data vault is processed by the third-party server by a method comprising:
a. record creation, wherein the third-party server creates and stores records for the encrypted data vault, including the vault name, universally unique identifier, trigger instructions or policy parameters, file names of digital data and encrypted data set, details of trustees'accounts and their assigned roles, and any time delay or scheduled release parameters;
b. encryption and distribution, wherein the third-party server, within a secure, isolated enclave environment, generates a decryption key and encrypts the digital data into an encrypted data set using an industry-standard, algorithm-agnostic cryptographic method, applies an attempt attestation wrapper, and prepares the data set for decentralized distribution to the owner and file holder trustees;
c. key wrapping, storage, and data distribution, wherein the decryption key is post-quantum wrapped and securely transmitted to an external key management system (KMS) on another third-party server, and the encrypted data set is distributed to the data owner and designated file holder trustees;
d. secure deletion, wherein any temporary copies of the original and encrypted digital data set are deleted from the third-party server and the enclave, with storage space overwritten with random data to ensure irrecoverability.

The distribution of the encrypted digital data set may occur in multiple ways, including but not limited to the following examples, and is not limited to these methods. Other secure distribution mechanisms may be used as appropriate for the file type, size, or recipient requirements. If the data set contains a single file with a unique file extension and its size is below a predetermined email capacity limit, it is distributed as an email attachment. If the data set contains multiple files and the total size is below the email capacity limit, the files are compressed into a single zip file and distributed by email. If a single file exceeds the email capacity limit, a download link is generated by the third-party server and sent by email. If multiple files exceed the email capacity limit, they are compressed into a zip file and a download link is generated and sent by email.

Upon the occurrence of a trigger event or condition, the encrypted data vault is opened through a collaborative process. Each trustee assigned to the trust circle (validation role) logs into their user account on the third-party server, submits an independent request to open the vault, and provides details confirming the trigger event or condition. The owner and all trustees are notified by the third-party server via email or other notification methods that an open request has been made, including details of the trigger event or condition. Collaborative validation is performed in accordance with the RBAC policy defined by the data owner, such that the vault is opened only when the required level of trustee validation (e.g. unanimous, majority, or other threshold) is achieved.

To enable owner's review of the encrypted data vault, the data owner must request that trust circle trustees submit open vault requests (OVRs) as if a trigger event or condition had occurred. The collaborative validation process is performed in accordance with the RBAC policy defined by the data owner. During the review period, the owner may decrypt and save the vault contents. Upon such decryption and save by the owner, the system automatically resets the vault to a locked state, requiring renewed collaborative validation for any further access.

The invention may further comprise an optional function of setting a time delay for the release of the decryption key to the key holders after the encrypted data vault has been opened through collaborative validation in accordance with the RBAC policy defined by the data owner. The time delay has two effects on the decryption of the digital data set:
a. once the required collaborative validation is satisfied and the vault is opened, the time delay countdown begins before any key holder can access the decryption key;
b. during the time delay, the data owner has access to the decryption key, allowing the owner to review or decrypt the vault contents. If the owner decrypts and saves the vault contents during this period, the system automatically resets the vault to a locked state, requiring renewed collaborative validation for further access.

Decryption of the encrypted digital data set is performed by the key holder trustees or the data owner after the encrypted data vault has been opened through collaborative validation in accordance with the RBAC policy defined by the data owner. The third-party server, after validating the decryption key with the external key management system, decrypts the encrypted decryption key and the digital data set. The original digital data is then made available for download and saving to a digital storage device by the authorized key holder trustees or the data owner. After decryption and saving of the vault contents by the data owner or key trustee, the system automatically resets the vault to a locked state, requiring renewed collaborative validation for any further access.

If more than one key trustees are designated for the vault, a predefined countdown timer (as specified in the RBAC policy defined by the data owner) is initiated after the first key trustee decrypts and saves the vault file. During this period, additional key trustees may decrypt and save the file. Once the timer expires, the vault automatically resets to a locked state, requiring renewed collaborative validation for any further access.

An embodiment of the invention discloses a method comprising the following steps:
i. Account registrations of data owner and trustees on a third-party server (3PS), with assignment of roles, including but not limited to validation, storage, decryption, or any additional or custom roles as defined by the data owner or organizational policy, wherein unregistered trustees render the vault inoperable until completion (see Section 0011);
j. Creating and encrypting a digital data vault within a secure, isolated enclave, applying attempt attestation and post-quantum key wrapping, and distributing the encrypted data set for decentralized storage (see Section 0012);
k. Recording trigger events, instructions, and optional parameters (e.g., time delay, scheduled release) as part of the vault metadata (see Section 0013);
l. Unlocking the vault upon collaborative validation of a trigger event, with notifications to all associated users (see Section 0014);
m. Releasing the decryption key to authorized parties after RBAC satisfaction and any configured delay, enabling local decryption and automatic vault lock reset after each access (see Sections 0015 and 0016).

In an embodiment, the system architecture includes a third-party server comprising multiple functional components for implementing the secure vault management platform. These components include: (i) a secure enclave responsible for decrypting and encrypting digital data and generating an encrypted digital data set (DDS); (ii) a vault management module configured to create and process encrypted data vaults (EDVs), store vault metadata, and coordinate encryption workflows; (iii) a role-based access control (RBAC) engine that governs the assignment of trustee roles and enforcement of access control policies as defined by the data owner; (iv) a key management interface that transmits decryption keys—wrapped using post-quantum cryptography (PQC) methods—to an external key management system (KMS); and (v) an access validation module that collects and verifies open vault requests (OVRs) from trust circle trustees, determines whether the defined RBAC validation thresholds are satisfied, facilitates decryption key release, and ensures that the EDV is reset to a locked state after the data has been decrypted and saved. These components may be deployed as microservices within a cloud or hybrid environment and may utilize hardware-based or virtualized trusted execution environments (TEEs).

### Account Registration and Setup on Third Party Server (3PS):

1) Data Owner (DO) Registration:
   a) The Data Owner (DO) registers an account on the Third-Party Server (3PS).
   b) The 3PS creates a unique user account for the DO.
2) Data Trustees (DTTES) Setup:
   a) The DO adds Data Trustees (DTTES) as contacts in their 3PS Address Book.
   b) The 3PS sends email invitations to the selected DTTES, prompting them to register.
   c) DTTES complete their registration on the 3PS, and accounts are created for them.

If any selected DTTES remains unregistered, the vault is flagged as inoperable until all trustees complete their registration, at which point the vault becomes fully operational. The DO's Address Book on 3PS reflects the successful registration of each DTTES.

### Creation of Encrypted Data Vault (EDV) on Third-party Server (3PS):

1) Initiation of Encrypted Data Vault:
   a) The data owner (DO) initiates the creation of an encrypted data vault (EDV) on the 3PS.
   b) The EDV comprises:
   Trigger Definition: The DO defines a potential future event, condition, or policy-driven rule under which the vault should be opened by the data trustees (DTTES).
   Instructions: The DO specifies instructions for the DTTES to follow if the trigger occurs.
2) Digital Data Set (DDS):
   The Data Owner (DO) uploads digital data (DD) that is client-side encrypted for secure transit to the third-party server (3PS). Upon receipt, the data is decrypted within a secure, isolated enclave environment on the 3PS, and then re-encrypted using industry-standard, algorithm-agnostic encryption (SSE) within the enclave. Only this enclave-encrypted digital data set (DDS) is prepared for decentralized storage and is wrapped with an attempt attestation wrapper for brute-force resistance.
3) Trustee Roles and Assignment:
   a) The DO assigns specific roles to DTTES involved in the EDV. At least one DTTES must be assigned to each role, and a DTTES can hold multiple roles.
   b) The primary roles include, but are not limited to:
      i) Trust Circle (DTTES-TC): Responsible for collaborative validation of the trigger in accordance with the RBAC policy defined by the DO. DTTES-TC members each submit independent Open Vault Requests (OVRs) to the 3PS. The EDV is unlocked only when the required level of collaborative validation is achieved, as specified by the RBAC policy (e.g., unanimous, majority, or other threshold of OVRs).
      ii) File Holders (DTTES-F): Receive the encrypted DDS for decentralized storage, delivered via secure email attachment or download link.
      iii) Key Holders (DTTES-K): Entrusted with the decryption key, which is released after collaborative validation and any optional time delay.
Additional or custom roles may be assigned as required by the data owner or organizational policy.
   c) Roles may be assigned to DTTES who have not yet completed registration; if any assigned DTTES remains unregistered, the EDV is flagged as inoperable until all DTTES are registered.
   Unlocking of the EDV requires collaborative validation by trust circle trustees, with the required threshold (e.g., unanimous, majority, or other policy-defined number of OVRs) determined by the RBAC policy set by the data owner. No single trustee can unlock the vault independently.
4) Vault Definition and Triggers:
   c) The DO specifies instructions for DTTES to follow if a trigger occurs.
   b) the DO defines one or more triggers for EDV opening, which may include:
      i) Event, condition, or policy-driven rule;
      ii) The DO may set an optional time delay for the release of the decryption key to DTTES-K (Key Holders) after the EDV has been unlocked, allowing the DO a predefined period to review or intervene before key holders can access the decryption key;
      iii) Scheduled (datetime-based) release with a post-release safety-net period for owner intervention (vault recovery/auto key release mechanism);
      iv) Any combination of the above, as required by the DO's access control policy.
5) Naming, Metadata and Parameter Configuration:
   c) The DO assigns a unique name to each EDV at the time of creation.
   d) The Data Owner (DO) specifies one or more trigger events or conditions that will initiate the decryption process for the encrypted data vault (EDV). These trigger events or conditions are recorded in the EDV metadata and may include, for example, the death or incapacitation of the owner, an emergency, or, if the vault recovery/auto key release mechanism is enabled, a specific future date for scheduled release. The DO also provides instructions to be followed by the trustees if the trigger event or condition occurs; these instructions are likewise recorded in the EDV metadata and are made available to trustees upon initiation of the vault unlocking process.
   e) The DO assigns a file name to Digital Data (DD) file before uploading to the Third-Party Server (3PS) for processing and encryption.
   f) The 3PS records and stores the EDV name, universally unique identifier (UUID), file names of the DD and Digital Data Set (DDS), and other relevant metadata as part of the EDV record for future retrieval, audit, and notification purposes.
   g) The DO may configure an optional key release delay (time delay) for the decryption key, specifying a predefined period that must elapse after collaborative validation before key holders (DTTES-K) can access the decryption key, allowing the DO a window for review or intervention.
   h) The DO may also configure a scheduled (datetime-based) vault recovery/auto key release mechanism, specifying a future date and time at which the EDV will automatically unlock and the decryption key will be released, optionally paired with a post-release safety-net period for owner intervention. The scheduled release mechanism must be elected and the scheduled datetime set forward (to a future date/time) at the time of EDV creation. If a safety-net period is configured, it must be set at the time of EDV creation and is immutable thereafter. If no owner intervention occurs during this safety-net period, the decryption key is automatically released to key holders.
   i) All such parameters including key release delay, scheduled release datetime, and safety-net period are recorded in the EDV metadata and are enforced by the 3PS as part of the RBAC-governed access policy.

### Processing of Encrypted Data Vault (EDV) by Third Party Server (3PS):

1) EDV Record Creation:
   a) The 3PS creates and stores records for the EDV, including the EDV name, trigger event(s) and instructions as specified by the Data Owner (DO), file name of Digital Data (DD) and Digital Data Set (DDS), details of Data Trustees (DTTES) accounts and their assigned roles, and all relevant access control parameters (such as key release delay, scheduled release datetime, and safety-net period).
   b) The DO's DD is temporarily stored within a secure, isolated enclave on the 3PS for processing.
2) Encryption, Key Generation and Distribution:
   a) The 3PS, within the secure enclave, encrypts the DD using an industry-standard, algorithm-agnostic cryptographic algorithm, producing the DDS (Digital Data Set).
   b) The 3PS generates a cryptographic key pair:
      i) Public Key: Stored within the EDV record on the 3PS.
      ii) Private Key: Securely transmitted to and stored in an external Key Management System (KMS) on another third-party server, with post-quantum cryptographic wrapping as required.
   c) The DDS is wrapped with a vault attempt attestation wrapper to resist brute-force decryption attempts.
   d) The DDS is then distributed to DTTES-F (File Holders) and the DO according to the following scenarios:
      i) Single File, Under Predetermined Size Limit:
      The DDS file is distributed as an email attachment to DTTES-F and the DO, with a unique file extension signifying its encrypted state.
      ii) Multiple Files, Under Predetermined Size Limit:
      The DDS files are compressed into a single. zip file and distributed by email to DTTES-F and the DO.
      iii) Single File, Over Predetermined Size Limit:
      A secure download link is generated by the 3PS and sent by email to DTTES-F and the DO, allowing them to download the encrypted file directly from the 3PS.
      iv) Multiple Files, Over Predetermined Size Limit:
      The DDS files are compressed into a. zip file, a secure download link is generated, and DTTES-F and the DO receive the link by email to download the .zip file from the 3PS.
3) Post-processing Data Deletion and Security
   a) After distribution, the 3PS ensures that all temporary copies of the DD and DDS, as well as any distributed DDS files and download links, are deleted from its server and the file space is overwritten multiple times with random data to ensure irrecoverability.
   b) The DDS files distributed via download link remain encrypted and secure until accessed by authorized DTTES-F and/or the DO. After access and download, the 3PS deletes the temporary download links and DDS files, again overwriting the file space to ensure unrecoverability.

### Unlocking of Encrypted Data Vault (EDV) on Third-party Server (3PS):

1) Collaborative Validation and Unlocking:
   a) Upon learning of the occurrence of a Trigger Event (TE) as defined by the Data Owner (DO) in the EDV, each Trust Circle Data Trustee (DTTES-TC) logs into their user account on the 3PS.
   b) Each DTTES-TC selects the relevant EDV associated with the TE and submits an independent Open Vault Request (OVR) on the 3PS, providing details of the TE to be shared with other DTTES-TC and DTTES.
   c) All DTTES and the DO are notified by the 3PS via email or other notification method that an OVR has been submitted by a DTTES-TC, along with the TE details.
   d) The DO may, at any time, reset the status of the EDV to clear all DTTES-TC OVRs, returning the EDV to a locked state with no pending OVRs.
   e) This process is repeated by other DTTES-TC as they independently validate and agree that the TE has occurred. Collaborative validation is performed in accordance with the RBAC policy defined by the DO (e.g. unanimous, majority, or other threshold). The EDV status is changed to unlocked/open on the 3PS once the required level of DTTES-TC OVRs is achieved.
   f) If an optional time delay parameter is set by the DO for the EDV, the following applies after unlocking:
      i) Once the required collaborative validation is satisfied and the EDV is unlocked, the time delay countdown begins before any Key Holders (DTTES-K) can access the decryption key.
      ii) During the time delay, the DO may access the decryption key to review, intervene, or decrypt the EDV contents. The DO may intervene at any time during this period to reset the EDV to a locked state, cancelling the key release; or review vault contents by decrypting and saving the decrypted file(s). If the DO decrypts and saves the EDV during this period, the system automatically resets the EDV to a locked state, requiring renewed collaborative validation for further access.
2) Owner-initiated Review (Owner Unlock):
   a) If the DO wishes to review the EDV without an actual TE occurrence, the DO must request that DTTES-TC submit OVRs as if a TE had occurred, following the same collaborative validation process as above.
   b) Before sending such a request, the DO should ensure that a time delay is set to prevent DTTES-K from receiving the decryption key, so that only the DO has access to the decryption key during this period.
   c) After the DO decrypts and saves the EDV contents for review, the system automatically resets the EDV to a locked state to prevent further access by DTTES or DTTES-K, as the unlocking was solely for DO review and not due to an actual TE.
3) Owner-Initiated Review via Scheduled Datetime Release (Vault Recovery option):
Alternatively, the Data Owner (DO) may configure the Encrypted Data Vault (EDV) with a scheduled (datetime-based) release mechanism (Vault Recovery option), paired with a post-release safety-net period for owner intervention. The election and configuration of the scheduled (datetime-based) release mechanism must occur at the time of EDV creation, and the scheduled datetime can only be set forward (to a future date/time). If a safety-net period is configured, it must be set at the time of EDV creation and is immutable and cannot be changed or overridden after creation. At the scheduled release time, the EDV automatically unlocks and the decryption key becomes available to the DO for review during the safety-net period. If the DO decrypts and saves the EDV during this period, the system auto-relocks the EDV and allows the DO to reschedule a future release as needed. If no owner intervention occurs during the safety-net period, the decryption key is then released to the Key Holders (DTTES-K) and the EDV remains open according to the RBAC policy. This mechanism enables the DO to review or recover the EDV without requiring trust circle collaborative validation, and provides a rolling, owner-controlled review and access workflow.

### Decryption of Unlocked Encrypted Data Vault (EDV) on Third-Party Server (3PS):

1) Eligibility and Preconditions:
   a) Once collaborative validation (per the RBAC policy defined by the Data Owner (DO)) is satisfied and the EDV lock status is changed to Unlocked, Data Trustee Key Holders (DTTES-K) and/or the DO may decrypt the Digital Data Set (DDS) on the 3PS, subject to any time delay or scheduled release parameters set by the DO.
   b) The DTTES-K or DO selects the EDV and uploads the DDS to the 3PS Decrypt function.
   c) The DTTES-K or DO utilizes the Decryption Key Lookup Tool, and the 3PS validates:
      i) The EDV is Unlocked.
      ii) The user is a registered DTTES-K or the DO for that specific EDV.
      iii) The user has permission for decryption for that EDV (per RBAC policy).
      iv) Any time delay or scheduled release period set by the DO for decryption key access has elapsed for DTTES-K.
      v) The public key in the EDV matches the private encryption key in the external Key Management System (KMS).
2) Key Release and Decryption:
   a) If all conditions in 1c are satisfied, the 3PS automatically populates the Decryption Key into the Decrypt function for the authorized DTTES-K or DO.
   b) The DTTES-K or DO then submits the DDS, public decryption key, and credentials to the 3PS for processing and secure interaction with the external KMS.
   c) The 3PS, after validation with the KMS, decrypts the DDS within the secure enclave and returns the original Digital Data (DD) file(s) with their original file names and extensions (as recorded in the EDV metadata) to the authorized DTTES-K or DO for download and saving to their device.
3) Auto-lock/reset:
   a) Upon decryption and saving of the DDS by the DO or any DTTES-K, the system automatically resets the EDV to a locked state, requiring renewed collaborative validation for any further access.
   b) If multiple DTTES-K are authorized, a configurable countdown timer may be initiated after the first decryption and save, allowing additional DTTES-K to decrypt and save within the allotted time, after which the EDV is auto-locked.

Another embodiment of the invention is the method for Sending Encrypted Email Attachments with Controlled Decryption Key Release:
1. A registered user on the 3PS can send an email with an encrypted attachment through the 3PS to one or more non-registered 3PS recipient(s).
2. The sender may configure a scheduled (datetime-based) release for the decryption key, which must be set to a future date/time at the time of sending (e.g., for press releases, birthday cards, public financial disclosures, etc.). The scheduled release mechanism must be elected and configured at the time of sending, and the scheduled datetime can only be set forward (to a future date/time). Once set, this release time is immutable.
3. Recipient(s) must register and create an account on the 3PS to access the decryption engine and retrieve the key after the scheduled release time.
4. The sender may delete the encrypted email attachment record at any time, this will prevent the recipient from ever being able to retrieve the decryption key and decrypting and saving attachment.
5. Attachments are encrypted using the same algorithm-agnostic, post-quantum ready cryptographic methods as described elsewhere in this specification.

### ADVANTAGES OF THE INVENTION

### 1. Role-Based Access Control (RBAC) as Core Innovation:

The system's primary novelty is its use of RBAC to govern all access to encrypted data vaults. Trustees are assigned flexible, owner-defined roles (such as validation, file holder, key holder), and all decryption and data release workflows are policy-driven, enabling sophisticated, collaborative, and auditable access control. This approach supports a wide range of organizational, legal, and operational requirements and is not limited to event-or circumstance-based triggers.

### 2. Algorithm Agnostic and PQC Ready:

The system is encryption algorithm agnostic, supporting any current or future cryptographic standard. It is designed for seamless adoption of post-quantum cryptography (PQC) by using PQC-ready key wrapping and attempt attestation wrappers to resist brute-force and quantum attacks. This ensures long-term data security and compliance as cryptographic standards evolve.

The architecture supports end-to-end hybrid encryption, with client-side encryption for secure transit and mandatory server-side re-encryption in a secure enclave, ensuring zero-knowledge security for the platform and persistent post-quantum protection for stored data.

### 3. Zero-knowledge Security for Platform Operator:

The system is architected to maintain a zero-knowledge security posture for the platform operator and any third-party server, except as expressly permitted by the RBAC policy. All encryption, decryption, and key management operations are performed within secure, isolated enclave environments and external key management systems. At no point does the platform operator have access to plaintext data or decryption keys, ensuring that only authorized trustees or the data owner, as defined by policy, can access sensitive information. This architecture provides strong privacy assurances and compliance with the strictest data protection standards.

### 4. Event, Condition, or Policy-driven Conditional Release:

Encrypted data is only released upon the occurrence of predefined events, conditions, or scheduled policies set by the data owner. This includes both classic event triggers (e.g. death, emergency) and flexible, policy-driven or time-based releases, ensuring data is only accessible when truly needed.

### 5. Collaborative Security and Validation:

The system requires collaborative validation by multiple trustees (e.g. trust circle), where each must independently confirm the trigger event or satisfy the RBAC policy before decryption keys are released. This prevents premature or unauthorized access and ensures every release is authenticated by multiple trusted sources.

### 6. Decentralized Storage and Distribution:

Encrypted data sets are distributed to file holder trustees and/or the data owner, creating a decentralized storage model that eliminates single points of failure and enhances security. Storage locations are trustee-selected and unknown to the third-party server, further reducing attack surfaces.

### 7. Optional Time Delay and Owner Review:

The owner can configure a time delay between validation and decryption key release, allowing a review or intervention window before trustees gain access. This provides additional control and auditability for sensitive releases.

### 8. Optional Vault Recovery and Auto Key Release Mechanism:

The system introduces a scheduled (datetime-based) release mechanism (vault recovery/auto key release) with a post-release safety-net period for owner intervention. The scheduled release mechanism must be elected and configured by the data owner at the time of vault creation, and the scheduled datetime can only be set forward (to a future date/time, like a deadman switch). If a safety-net period is configured, it must be set at the time of vault creation and is immutable thereafter. If the owner does not intervene during the safety-net, the decryption key is automatically released to trustees. This fail-safe ensures data recovery in cases of owner incapacitation, deadlock, or trustee disagreement, and enables rolling, owner-controlled scheduled releases.

### 9. Automatic Vault Lock Reset:

After decryption and save by the owner or a key trustee, the system automatically resets the vault to a locked state, requiring renewed collaborative validation for further access. This prevents repeated or unauthorized access after an initial unlock and enhances operational security.

### 10. Resilience Against Multiple Account Compromises:

The combination of collaborative validation, decentralized storage, and cryptographic controls ensures that even if multiple user accounts are compromised, the integrity and confidentiality of the encrypted vault and its contents remain intact.

### 11. Flexibility and Future-proofing:

The system is adaptable to a wide range of trigger events, legal requirements, and future scenarios. The RBAC-driven architecture and policy-driven workflows support evolving user, organizational, and regulatory needs, and can integrate new cryptographic and operational features as standards advance.

### 12. Industry Standard Security Practices:

The platform supports audit trails, immutable time clocks, in-app and email notifications, and database encryption at rest. These features ensure compliance with industry standard best practices and provide transparency, traceability, and operational confidence.

This invention provides a secure, future-proof method and computer system for controlled encryption, decentralized storage, and conditional decryption of sensitive digital data. Access to encrypted data vaults is governed by flexible, owner-defined Role-Based Access Control (RBAC) policies, enabling collaborative validation, granular role assignment, and policy-driven access thresholds. The system is encryption algorithm agnostic and post-quantum cryptography (PQC) ready, utilizing end-to-end hybrid encryption and secure enclave processing to ensure long-term security and adaptability to evolving cryptographic standards.

Conditional data release is triggered by predefined events, conditions, or scheduled policies, with additional support for time delays and a vault recovery/auto key release mechanism. The scheduled (datetime-based) release mechanism must be elected and configured at the time of vault creation, the scheduled datetime can only be set forward (to a future date/time), and if a safety-net period is configured, it must be set at the time of creation and is immutable thereafter. Decentralized storage distributes encrypted data sets to file holders and owners, eliminating single points of failure and enhancing privacy. Collaborative validation among trustees, combined with optional time delays and automatic vault lock resets after decryption, provides robust protection against unauthorized or premature access.

This architecture delivers high security, operational flexibility, and resilience for digital data owners and trustees, supporting a wide range of use cases, legal requirements, and future scenarios.

What is claimed is:

1. A computer-implemented method for controlled encryption, decentralized storage, and conditional decryption of digital data, the method comprising:
registering a data owner by creating a unique user account on a third-party server;
registering data trustees selected by the data owner and allowing assignment of roles to unregistered trustees;
dividing the trustees into one or more groups and assigning to each group one or more predefined roles in accordance with a role-based access control (RBAC) policy defined by the data owner, the predefined roles comprising a validation role, a file holder role, and a key holder role, and being extensible to other roles as permitted by the RBAC policy, wherein the RBAC policy governs access privileges, responsibilities, and conditions associated with each assigned role;
encrypting digital data using an algorithm-agnostic, that is an industry-standard cryptographic method, to generate an encrypted digital data set (DDS);
creating an encrypted data vault (EDV) comprising:
a trigger definition specifying a trigger as one or more events, conditions, or RBAC policy-driven rules under which the EDV is to be opened;
instructions provided by the data owner to be followed by the trustees if the trigger occurs;
a set of parameters comprising a key release delay and a scheduled release mechanism, wherein the scheduled release mechanism is configured only upon election at the time of encrypted data vault creation, a scheduled datetime is required to be set to a future date and time upon such election, and a safety-net period is configurable only upon a further election that is dependent on the election of the scheduled release mechanism, and when so configured, the safety-net period is fixed and immutable after the time of encrypted data vault creation; and
wherein the encrypted data vault is flagged as inoperable until all the trustees registered by the data owner have completed their registration;
processing the EDV in a secure, isolated enclave, comprising generating a decryption key, wrapping the decryption key with post-quantum cryptography (PQC) methods, and applying an attempt attestation wrapper to the DDS;
transmitting the decryption key to an external key management system (KMS) on another third-party server, and distributing the DDS to file holder trustees and/or the data owner for decentralized storage;
deleting all temporary copies of the digital data and the DDS from the third-party server and overwriting storage space with random data to ensure irrecoverability;
unlocking the EDV by collaborative validation of the trigger, performed according to the RBAC policy with each validation trustee submitting an independent open vault request (OVR);
releasing the decryption key to the key holder trustee and/or the data owner only after satisfaction of the RBAC policy, expiration of any configured time delay or the safety-net period, and the validation with the KMS; and
decrypting the DDS using the decryption key, and automatically resetting the EDV to a locked state after the decryption and save by the data owner or the key trustee, requiring renewed collaborative validation for further access.

2. The method of claim 1, wherein a system, executing the method, is zero-knowledge for platform operator except as permitted by the RBAC policy.

3. The method of claim 1, wherein the registration of the data trustees comprises:
for each user of the third-party server, maintaining an address book that stores contact entries;
adding one or more data trustees as contact entries in data owner's address book;
verifying, for each added contact entry, whether corresponding email address exists in a platform-wide list of registered users maintained by the third-party server;
determining that the data trustee is eligible for role assignment in the encrypted data vault (EDV) only if the email address of that trustee exists in the platform-wide list of the registered users; and
flagging the EDV as inoperable until all the data trustees assigned to the EDV are confirmed as the registered users on the platform; and
displaying, in the data owner's address book, an indication of registration status for each contact, the indication comprising a column showing whether the contact is registered, including a checkmark for each contact that is confirmed as the registered user.

4. The method of claim 1, wherein the groups of trustees comprise:
the validation (trust circle) trustees responsible for the collaborative validation of the trigger in accordance with the RBAC policy;
the file holder trustees who receive and store the DDS; and
the key holder trustees who receive the decryption key after the EDV is unlocked.

5. The method of claim 4, wherein each group of the trustees comprises one or more trustees, and each trustee can be assigned a single or multiple roles.

6. The method of claim 1, wherein the EDV is processed by the third-party server by:
creating and storing EDV records including vault name, UUID (Universally Unique Identifier), the trigger definition, the instructions, file names, the trustee roles, the key release delay, the scheduled release and safety-net parameters, wherein the scheduled release mechanism is configured only if elected at the time of the encrypted data vault creation, the scheduled datetime is required to be set to a future date/time upon such election, and the safety-net period is configured only if elected as a conditional sub-configuration of the scheduled release mechanism, and when configured, the safety-net period is fixed and immutable after the time of encrypted data vault creation;
encrypting the digital data in the secure enclave to produce the DDS;
generating the decryption key wrapped by the PQC methods, storing it in the external KMS;
distributing the DDS to the file holder trustees and/or the data owner; and
deleting all the temporary copies and overwriting the storage space for irrecoverability.

7. The method of claim 1, wherein the secure, isolated enclave environment comprises a hardware-based, cloud-based, or virtualized trusted execution environment (TEE).

8. The method of claim 1, wherein the DDS is distributed by an email if it is a single file below a predetermined size limit, and by a secure download link if it is a single file above the predetermined size limit.

9. The method of claim 1, wherein if the DDS comprises multiple DDS files below the predetermined size limit, these files are compressed and distributed by the email.

10. The method of claim 1, wherein if the DDS comprises multiple DDS files exceeding the predetermined size limit, these files are compressed and distributed by the secure download link.

11. The method of claim 1, wherein the unlocking of the EDV comprises:
each validation trustee independently submitting an OVR;
the collaborative validation being performed according to the RBAC policy defined by the data owner;
notifying all the trustees and the data owner of each OVR and trigger details; and
unlocking the EDV once required RBAC threshold is met.

12. The method of claim 1, further comprising setting a time delay for the decryption key release after the unlocking, during which only the data owner has access to the decryption key for review or intervention.

13. The method of claim 12, wherein:
countdown of the time delay begins upon satisfaction of the RBAC policy and the unlocking;
the data owner reviews or decrypts the DDS during the delay time; and
after the decryption and save by the data owner, the EDV is automatically reset to the locked state.

14. The method of claim 13, wherein the review by the data owner is performed by:
requesting the validation trustees to submit OVRs as if the trigger occurred, or
configuring the scheduled (datetime-based) release with the safety-net period for the intervention, wherein the scheduled release mechanism is elected and configured at the time of the encrypted data vault creation, the scheduled datetime is set forward (to the future date/time), and the safety-net period, if elected, is set at the time of the encrypted data vault creation and is immutable thereafter, during which the data owner accesses and reviews the EDV, with auto-lock/reset and rescheduling if the data owner intervenes.

15. The method of claim 1, wherein the decryption of the DDS is performed by:
authorized key holder trustees or the data owner after the unlocking and expiration of the time delay or the safety-net period; by
validating the decryption key with the external KMS;
decrypting the DDS and providing original digital data for downloading and saving; and
automatically resetting the EDV to the locked state after the decryption and save.

16. The method of claim 1, further comprising a method for sending encrypted attachments by the email, wherein:
a registered user on the third-party server sends the email with an encrypted attachment to one or more unregistered trustees;
the sender may configure a date and time for the decryption key release;
the unregistered trustees receiving the email register themselves on the third-party server to access decryption engine and retrieve the decryption key after the scheduled release.

17. The method of claim 1, wherein there is a system, executing the method, and the system is encryption algorithm agnostic and post-quantum cryptography (PQC) ready, supporting future cryptographic standards without fundamental redesign.

18. The method of claim 17, wherein the system applies the attempt attestation wrapper to the DDS to resist brute-force decryption attempts and supports audit trails, immutable time clocks, and notifications as industry-standard security features.

19. A computer system for controlled encryption, decentralized storage, and conditional decryption of digital data, the system comprising:
a third-party server;
a secure enclave configured to decrypt client-side encrypted (CSE) files provided by the data owner, re-encrypt the files using server-side encryption (SSE) methods, and generate an encrypted digital data set (DDS);
a vault management module configured to create and process encrypted data vaults (EDVs);
a role-based access control (RBAC) engine configured to assign roles to trustees and enforce policy-defined access validation;
a key management interface configured to transmit a decryption key wrapped with post-quantum cryptography (PQC) to an external key management system (KMS);
and an access validation module configured to receive open vault requests (OVRs), validate trigger events, release decryption keys, and automatically reset the EDV to a locked state following decryption and save.
